(19) United States
(12) Patent Application Publication
(10) Pub. No.: US 2009/0019184 A1
(43) Pub. Date: Jan. 15, 2009

(54) INTERFACING MEMORY DEVICES

(75) Inventors: Maurizio Skerlj, Munchen (DE); Christian Muller, Worth (DE); David Muller, Unterhaching (DE); Dirk Friebe, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 11/775,785

(22) Filed: Jul. 10, 2007

(51) Int. Cl. G06F 3/00

(52) U.S. Cl. 710/5

(57) ABSTRACT

An integrated circuit includes a memory interface circuit. The memory interface circuit includes a first interface channel configured to couple to at least one memory device, a second interface channel configured to couple to at least one memory device, and a multiplexer configured to select between the first interface channel and the second interface channel.

### BACKGROUND

Electronic data processing systems, such as computer systems, typically include one or more memory devices for storing data. Memory interface circuits are typically employed to interface between a plurality of memory devices.

### SUMMARY

One embodiment provides an integrated circuit containing a memory interface circuit. The memory interface circuit includes a first interface channel configured to couple to at least one memory device and a second interface channel configured to couple to at least one memory device. The memory interface circuit includes a multiplexer configured to select between the first interface channel and the second interface channel.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a data processing system according to an embodiment, in which memory devices are coupled to a memory buffer device using a memory interface according to an embodiment.

FIG. 2 illustrates an embodiment of a memory buffer device of FIG. 1.

FIG. 3 illustrates a memory interface circuit according to an embodiment.

FIG. 4 illustrates a data processing system according to an embodiment, in which a plurality of memory devices are coupled to a memory buffer using a memory interface according to an embodiment.

FIG. 5 illustrates a data processing system according to an embodiment, in which a plurality of memory devices are coupled to a memory controller using a memory interface according to an embodiment.

FIG. 6 illustrates a data processing system according to an embodiment, in which a plurality of memory devices are coupled to a processor using a memory interface according to an embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

It is to be understood that in the following detailed description any shown or described direct connection or coupling between two functional blocks, devices, components, or other physical or functional units could also be implemented by indirect connection or coupling.

In the following, embodiments are described with reference to the accompanying drawings. Embodiments relate to a method of interfacing a plurality of memory devices in a data processing system, a corresponding memory interface circuit, a corresponding memory buffer device, a corresponding memory controller, and a corresponding processor. The interfaced memory devices embodiments may be integrated circuits comprising one or more memory arrays. Integrated circuits comprising one or more memory arrays may implement present or future standards, including double data rate (DDR), DDR2, DDR3, etc. The memory devices may be dynamic random access memory (DRAM) type or DRAM chips. However, it is to be understood that the concepts described hereinafter could also be applied to other types of memory devices.

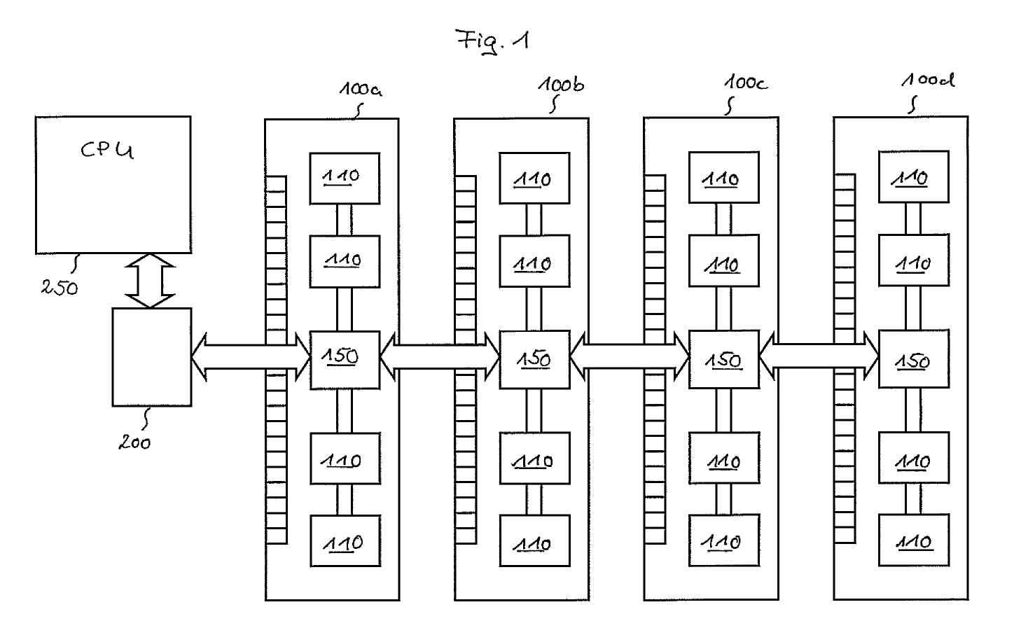

FIG. 1 illustrates one embodiment of a data processing system. The data processing system comprises a processor 250 (e.g., a central processing unit (CPU)). The processor 250 communicates with a memory comprising a plurality of memory modules 100a, 100b, 100c, and 100d. This is accomplished via a memory controller 200. The memory controller 200 communicates via a host interface with the processor 250 and further communicates via a high-speed interface with the memory modules 100a, 100b, 100c, and 100d. The high-speed interface may be a multi-channel serial type interface.

Each of the memory modules comprises a plurality of memory devices 110 (e.g., DRAM chips). The memory devices 110 of a memory module 100a, 100b, 100c, and 100d are coupled to the memory controller 200 via a memory buffer device 150 of the memory module. The memory buffer device 150 communicates with the memory controller 200 via a controller interface coupled to the high-speed interface of the memory controller 200 and communicates with the memory devices 110 of the memory module via a memory interface. The memory buffer device 150 may be configured to communicate with a further memory buffer device so as to connect a plurality of memory modules 100a, 100b, 100c, and 100d in a chain configuration. The memory buffer device may be implemented in an integrated circuit.

According to an embodiment, the memory modules 100a, 100b, 100c, and 100d may correspond to a dual inline memory module (DIMM) type. More specifically, the memory modules 100a, 100b, 100c, and 100d may each correspond to a fully-buffered DIMM (FB-DIMM) and the memory buffer device 150 may correspond to an advanced memory buffer (AMB). In other embodiments, other types of memory modules may be used.

According to an embodiment, the processor 250, the memory controller 200, each of the memory devices 110, and the memory buffer device 150 are each implemented on a corresponding semiconductor chip. Accordingly, the memory devices may also be referred to as memory integrated circuits. Also the processor, the memory controller, and the memory buffer device may be formed in a corresponding integrated circuit. The memory modules 100a, 100b, 100c, and 100d are formed by arranging a plurality of the memory devices 110 and the memory buffer device 150 on a printed circuit board. On the printed circuit board, a plurality of connection pins are formed to couple the memory module 100a, 100b, 100c, and 100d to the memory controller 200. In other embodiments, at least some of the above functions could be integrated on a single chip. For example, the processor and the memory controller could be integrated on a single chip.

Referring to FIG. 2, a structure of a memory buffer device 150 is further explained by referring to an exemplary embodiment. As illustrated in FIG. 2, the exemplary embodiment of memory buffer device 150 comprises a core logic 155, a controller interface or high-speed interface 190 (e.g., a multi channel serial type interface), a pair of CA-blocks 160, and a plurality of DQ8-blocks 170. The memory buffer device 150 is configured to translate commands and data received via the high-speed interface 190 from the memory controller into specific memory commands for the memory devices 110 and to perform write and read operations on the memory devices 110 via the memory interface. The memory interface comprises the pair of CA-blocks 160 and the DQ8-blocks 170. In the illustrated example, the number of DQ8-blocks 170 is nine. In other embodiments, different numbers of CA-blocks 160 and different numbers of DQ8-blocks may be used. The core logic 155 is configured to accomplish the processing for translating the data and commands and accomplishing the write and read operations.

The CA-blocks 160 are employed for the transfer of command and address data. According to an embodiment, buffers are included in the CA-blocks 160 for transferring command signals, clock signals, and address signals to the connected memory devices 110.

The DQ8-blocks are each provided with a number of data transceivers for transferring data path or DQ signals via the memory interface and a number of transceivers for transferring data strobe signals, herein referred to as DQS/DQS# signals, via the memory interface. The memory interface of the illustrated embodiment is a bidirectional type with respect to the direction of data flow to and from a given memory device. In other embodiments the memory interface may be of a unidirectional type and different memory interfaces may be used for the different directions of data flow.

According to an embodiment, a plurality of memory devices 110 or multiple ranks of memories may be connected to a single DQ8-block 170. A multi-rank configuration may have multiple ranks of memories on a single memory module or on different memory modules. In such a multi-rank configuration embodiment, the connected components may not be used at the same time and the interface has to be scheduled in a way that there is no bus contention when switching from one to the other rank. The number of ranks is limited by the maximum tolerable capacitive load on the memory interface. An excessive capacitive load may be compensated by decreasing the speed of the memory interface.

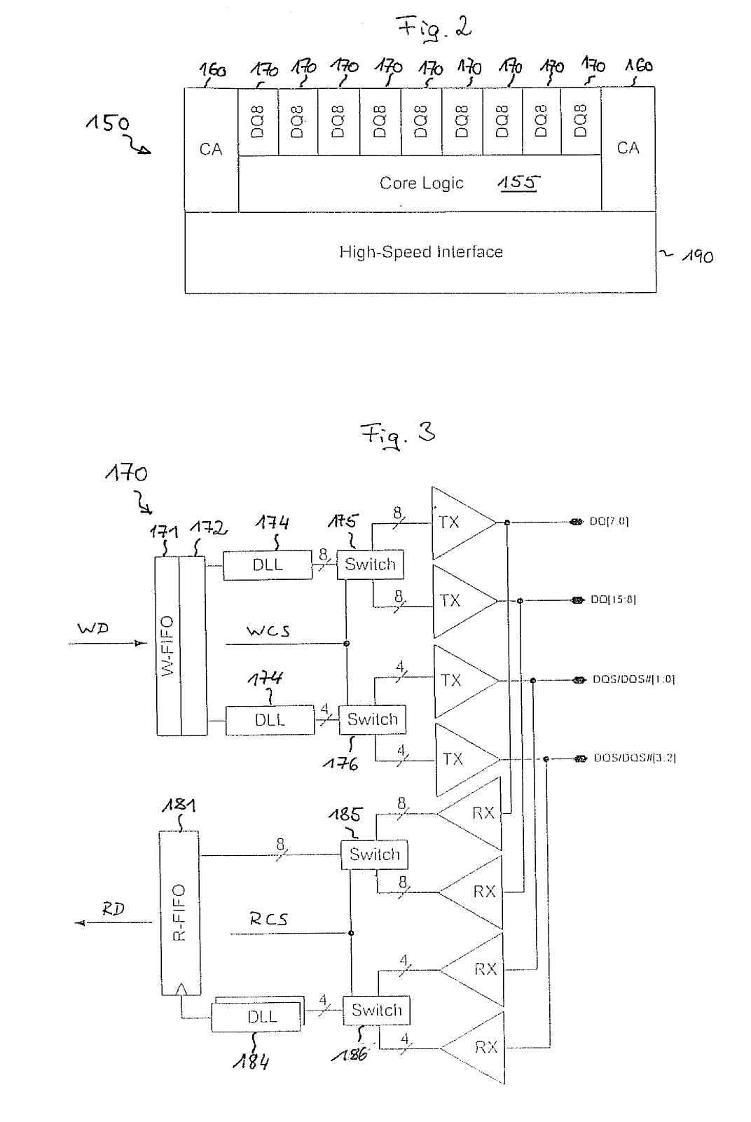

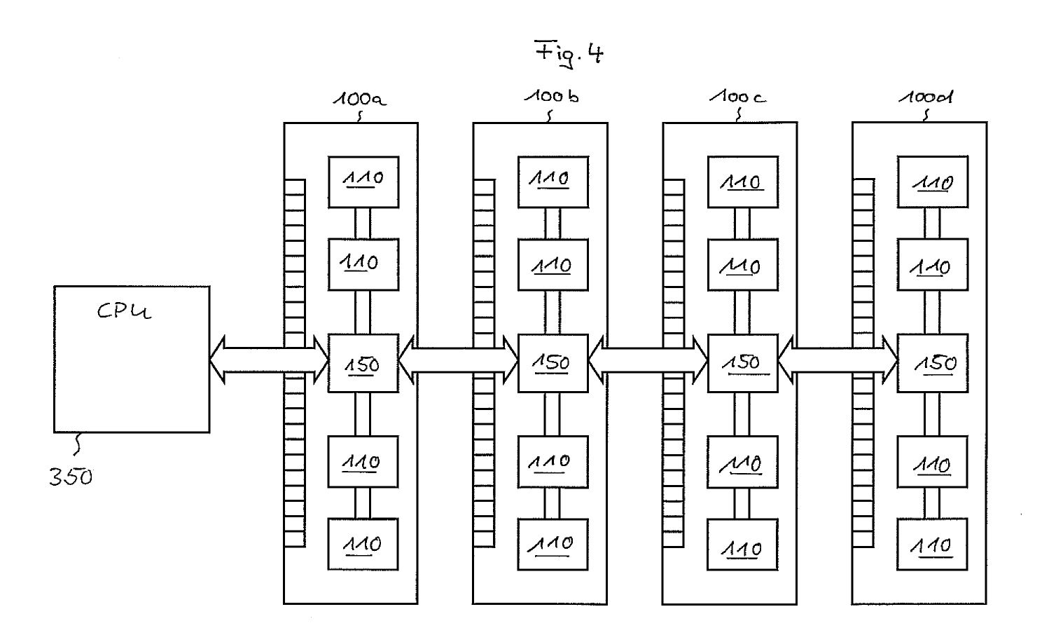

Now referring to FIG. 3, a structure of DQ8-blocks 170 of the memory interface is further explained with reference to an exemplary embodiment of a DQ8-block 170. As illustrated, the DQ8-block comprises a plurality of transmitters (TX) for transmitting data to the memory devices 110 and a plurality of receivers (RX) for receiving data from the memory devices 110. The DQ8-block 170 comprises a write section which is generally responsible for generating DQ signals and DQS/DQS# signals in write operations and a receive section which is generally responsible for receiving DQ signals and DQS/DQS# signals in read operations.

The write section comprises a write buffer 171, such as write first-in first-out (W-FIFO), and a control logic 172. The write buffer 171 receives write data WD from the core logic (not illustrated in FIG. 3) via a respective line or bus. The read section comprises a read buffer 181, such as read first-in first-out (R-FIFO). The read buffer 181 stores read data RD to be sent to the core logic via a respective line or bus. Further, the write section comprises delay circuitry in the form of delay lines or DLLs 174, which are coupled between the write buffer 171 and the transmitters TX. The read section comprises delay circuitry in the form of delay lines or DLLs 184 which are coupled between the receivers RX allocated to the DQS/DQS# signals and a control input of the read buffer 181. The write buffer and the read buffer form a buffer device of the memory interface circuit (i.e., an interface buffer).

Operation of a memory interface according to one embodiment is as follows. In an example write operation, the transmitters are controlled to send the write data stored in the write buffer 171 to the connected memory devices 110 via the transmitters TX. The transmitters TX drive the corresponding DQ signals and DQS/DQS# signals to the connected memory devices 110. In this operation, the core logic enables the transmitters at the right point of time, enables the correct memory rank, and properly skews the DQ signals and DQS/DQS# signals using the delay lines 174.

In an example read operation, the core logic enables the receivers RX at the right point in time, captures the read data in the read buffer 181, and sets the skewing of the DQS/DQS# signal with respect to the DQ signals via the delay line 184.

In the example embodiment of FIG. 3, the DQ8-block as illustrated comprises a first transmitter TX for transmitting a first group of eight DQ signals (DQ[7:0]), a second transmitter TX for transmitting a second group of eight DQ signals (DQ[15:8]), a third transmitter TX for transmitting a first group of four DQS/DQS# signals (DQS/DQS#[1:0]), and a fourth transmitter TX for transmitting a second group of four DQS/DQS# signals (DQS/DQS#[3:2]). Further, a first receiver RX receives a first group of eight DQ signals (DQ[7:0]), a second receiver RX receives a second group of eight DQ signals (DQ[15:8]), a third receiver RX receives a first group of four DQS/DQS# signals (DQS/DQS#[1:0]), and a fourth receiver RX receives a second group of four DQS/DQS# signals (DQS/DQS#[3:2]). In the example embodiment, the first transmitter TX and the first receiver RX are connected to the same interface terminals, the second transmitter TX and the second receiver RX are connected to the same interface terminals, the third transmitter TX and the third receiver RX are connected to the same interface terminals, and the fourth transmitter TX and the fourth receiver RX are connected to the same interface terminals. In this way, the signal lines coupled between the interface terminals and the memory devices are used in a bidirectional manner. Accordingly, considering that according to the exemplary embodiment of FIG. 2, the memory interface comprises nine DQ8-blocks 170, the memory interface comprises a total number of 144 interface terminals for the DQ signals, and a total number of 72 terminals for the DQS/DQS# signals. In other embodiments, different numbers of interface terminals may be used.

As further illustrated in FIG. 3, a DQ8-block 170 comprises a multiplexer device formed of switches 175, 176, 185, and 186. In the write section, a switch 175 is coupled between the write buffer 171 and the first and second transmitters TX for the DQ signals. Accordingly, either the interface terminals corresponding to the first group of DQ signals or the interface terminals corresponding to the second group of DQ signals can be selectively coupled to the write buffer 171 via the switch 175. The switch 176 is coupled between the write buffer 171 and the control logic 172, and the third and fourth transmitters TX for the DQS/DQS# signals so that either the interface terminals corresponding to the first group of DQS/DQS# signals or the interface terminal corresponding to the second group of DQS/DQS# signals can be selectively coupled to the write buffer 171 and write logic 172.

In the read section, the switch 185 is coupled between the read buffer 181 and the first and second receivers RX for the DQ signals. In this way, either the interface terminals corresponding to the first group of DQ signals or the interface terminals corresponding to the second group of DQ signals can be selectively coupled to the read buffer 181. The switch 186 is coupled between the control terminal of the read buffer 181 and the third and fourth receivers RX for the DQS/DQS# signals. In this way, either the interface terminals corresponding to the first group of DQS/DQS# signals or the interface terminals corresponding to the second group of DQS/DQS# signals can be selectively coupled to the read buffer 181.

The multiplexer device (i.e., the switches 175, 176, 185, 186) is controlled by a channel select signal. In particular, the switches 175, 176 are controlled by a write channel select signal WCS, and the switches 185, 186 are controlled by a read channel select signal RCS. The first group of DQ signals and the first group of DQS/DQS# signals form a first interface channel, and the second group of DQ signals and the second group of DQS/DQS# signals form a second interface channel. The first interface channel and the second interface channel form physically distinct signal connections. The first interface channel and the second interface channel are typically formed with a substantially identical configuration, but different configurations are possible.

Accordingly, in the memory interface circuit, the DQ signals and the DQS/DQS# signals are internally multiplexed so as to widen the memory interface.

The memory interface includes a first interface channel comprising the first group of DQ signals and the first group of DQS/DQS# signals and a second interface channel comprising the second group of DQ signals and the second group of DQS/DQS# signals. As illustrated, each of the interface channels is connected to a corresponding group of interface terminals. From the outside of the device, the first interface channel and the second interface channel appear as independent memory interfaces.

In the example embodiment of FIG. 3, the multiplexing occurs in such a way that only the number of transmitters TX and receivers RX is increased, but the other components of the memory interface (i.e., the write buffer 171), the write logic 172, the read buffer 181, and the delay lines 174, 184 are unaffected. This embodiment provides advantages with respect to power consumption and chip area requirements of the memory interface. In other embodiments, the multiplexing may be accomplished at other locations. For example, the multiplexing may be accomplished within the transmitters TX, within the receivers RX, within the write buffer, within the read buffer, within the delay lines or a combination thereof, according to implementation aspects.

The above exemplary embodiment structure of the memory interface allows for increasing the width of the memory interface in a very efficient manner. In one embodiment, the number of connected memory devices may be increased without decreasing the data transfer rate via the memory interface. In one embodiment, only a limited number of interface components needs to be increased to achieve the increased interface width. This embodiment provides advantages with respect to power consumption and chip area requirements. Further, the timing of write and read operations may be improved. As compared to writing different memory ranks connected to a single interface channel, when performing write operations via different interface channels which are multiplexed as according to above described embodiments, it is no longer required to wait for a write command on one interface channel to be entirely finished before starting a write operation on the other interface channel. Rather, the change between one interface channel and the other interface channel can already start right after the last data transfer of the first write operation has been completed, which is the first point in time when the switches 175, 176 can be changed. For example, a preamble of the second write operation could already be transmitted on the second interface channel while on the first interface channel there is still traffic pertaining to the first write operation.

Similar advantages exist in example read operations according to embodiments. If there is a read operation on one memory channel, the read data of a read operation on the other memory channel can arrive significantly earlier than in the case of multiple memory devices connected via a single interface channel.

Further, according to embodiments it is possible that a read operation on one interface channel and a write operation on the other interface channel are carried out at the same time.

As compared to a memory interface without multiplexing of interface channels, the number of transmitters or receivers which are active at the same time is typically not increased for a given memory size. Accordingly, the width of the memory interface described may be increased in a very power-efficient manner according to embodiments.

In the above described embodiments, the memory buffer device 150 communicates with the memory controller 200 via the high-speed interface. According to other embodiments, the memory buffer device may communicate with other components which are located external with respect to the memory module.

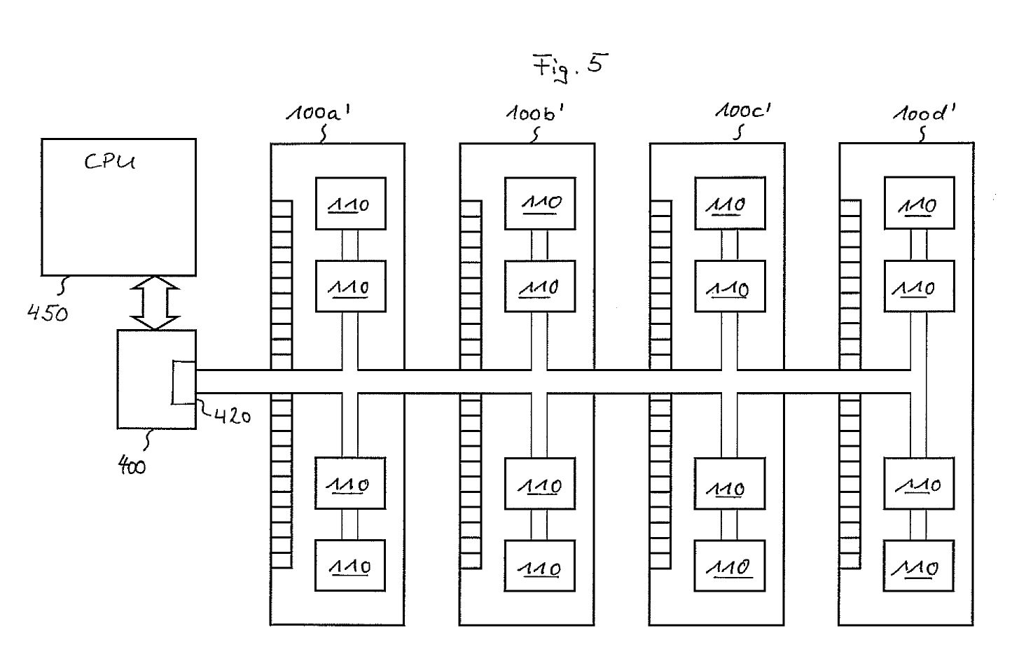

According to an embodiment illustrated in FIG. 4, a data processing system comprises a processor 350 and a plurality of memory modules 100a, 100b, 100c, and 100d. The memory modules 100a, 100b, 100c, and 100d generally correspond to those as described in connection with FIG. 1. In FIG. 4, components which correspond to those of FIG. 1 have been designated with the same reference numerals and further description thereof will be omitted.

As compared to the data processing system of FIG. 1, in the data processing system of FIG. 4 the processor 350 is configured to communicate directly with the memory buffer devices 150 of the memory modules 100a, 100b, 100c, and 100d. Accordingly, a separate memory controller is not required in this data processing system. Rather, functions of the memory controller 200 are implemented within the processor 350.

In the foregoing, the memory interface was described to be implemented within the memory buffer device 150 of the memory modules 100a, 100b and 100c, 100d. In other embodiments, the memory interface may be implemented within other components of a data processing system so as to accomplish interfacing of memory devices.

FIG. 5 schematically illustrates a data processing system according to an embodiment. The data processing system comprises a processor 450, a memory controller 400, and a plurality of memory modules 100a′, 100b′, 100c′, and 100d′. Accordingly, the data processing system embodiment of FIG. 5 has a similar structure as the data processing system embodiment of FIG. 1. In FIG. 5, components which are similar to those of FIG. 1 have been designated with corresponding reference numerals, and further description thereof will be omitted. However, as compared to the data processing system embodiment of FIG. 1, the memory modules 100a′, 100b′, 100c′, and 100d′ of the FIG. 5 embodiment do not comprise the memory buffer device 150. Accordingly, the memory modules 100a′, 100b′, 100c′, and 100d′ of this embodiment correspond to an unbuffered type.

In the data processing system embodiment of FIG. 5, the processor 450 communicates with the memory devices 110 on the memory modules 100a′, 100b′, 100c′, and 100d′ via the memory controller 400. For this purpose, the memory controller 400 comprises a host interface so as to communicate with the processor 450 and a memory interface 420 so as to communicate with the plurality of memory devices 110 of the memory modules 100a′, 100b′, 100c′, and 100d′. The memory interface 420 is configured as described for the memory interface embodiments of FIGS. 2 and 3.

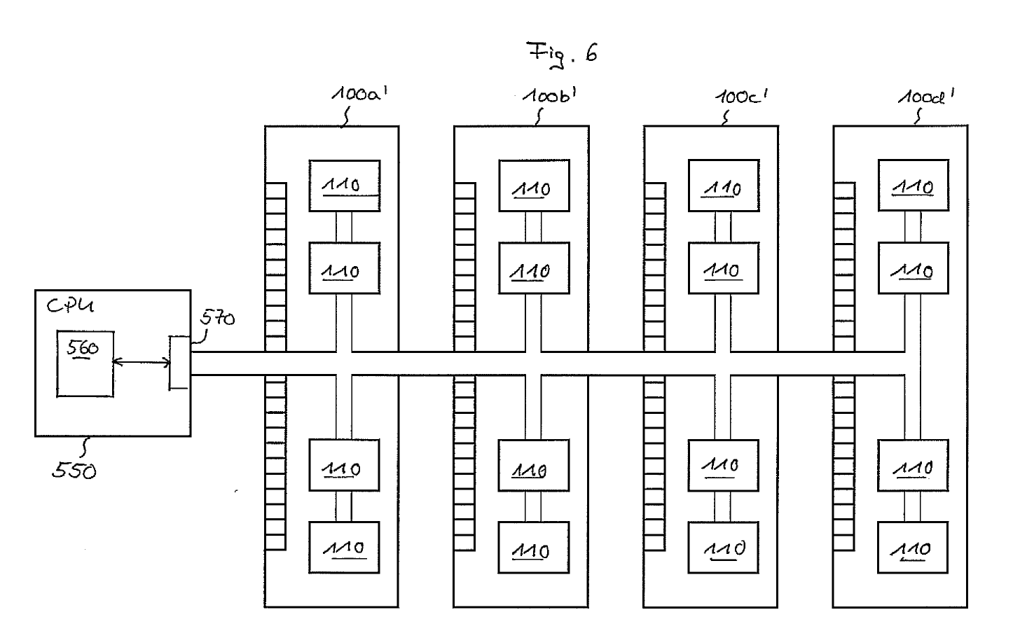

FIG. 6 schematically illustrates a data processing system according to an embodiment. The data processing system embodiment of FIG. 6 generally corresponds to the data processing system embodiment of FIG. 5 and similar components have been designated with corresponding reference numerals. However, as compared to the data processing system embodiment of FIG. 5, the data processing system embodiment of FIG. 6 comprises a processor 550 which is configured to directly communicate with the memory modules 100a′, 100b′, 100c′, and 100d′ via a memory interface 570. The memory interface 570 is configured as described in connection with the embodiments of FIGS. 2 and 3. However, in this embodiment the memory interface 570 serves to establish communication between a processor core 560 of the processor 550 and the plurality of memory devices 110 of the memory modules 100a′, 100b′, 100c′, and 100d′. In the data processing system embodiments of FIG. 6, no separate memory controller integrated circuit is required. Functions of a memory controller are implemented within the same integrated circuit where the processor 550 is located.

Accordingly, the above described embodiments of a memory interface can be applied to a variety of electronic components. In particular, memory interface embodiments may be used within a memory buffer device of a memory module, within a memory controller, which may be implemented in a separate chip on a main board of a data processing system, or in a processor. Memory interface embodiments may also be used in an integrated circuit implementing functions of a larger system on a single chip. Such an integrated circuit embodiment could comprise an embedded processor and an embedded memory. However, memory interface embodiments are not limited to these applications and may be used in other components as well.

Further, the above described embodiments of a memory interface are configured to accomplish both write operations and read operations via two interface channels which are internally multiplexed within the circuit structure of the memory interface. In other embodiments, a larger number of interface channels may be used. Further, the above-described concepts may also be applied in a memory interface embodiments which is dedicated to read operations only or to write operations only. It is also possible to implement a memory interface embodiment in which the write section has multiplexed interface channels and the read section has a single interface channel or a memory interface in which the read section has multiplexed interface channels and the write section has a single interface channel. Further, multiplexing between the first interface channel and the second interface channel could also be implemented only for the data path signals or only for the data strobe signals.

Further, the above concepts may be applied in connection with a variety of memory devices, the above-mentioned DRAM devices being only one example thereof. Further, the above described embodiments could also be combined with each other, for example in a data processing system which comprises memory modules of both buffered type and unbuffered type.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of interfacing a plurality of memory devices, comprising:
providing a memory interface having at least a first interface channel configured to couple to at least one memory device and a second interface channel to configured to couple to at least one memory device; and
selecting, with a multiplexer, between the first interface channel and the second interface channel.

2. The method according to claim 1, comprising:
providing the first interface channel with a first group of interface terminals;
providing the second interface channel with a second group of interface terminals;
arranging the multiplexer between a buffer and the first and second groups of interface terminals; and
selectively coupling the first group of interface terminals or the second group of interface terminals to the buffer.

3. The method according to claim 2,
wherein the buffer comprises a read buffer;
wherein the multiplexer comprises a read multiplexer arranged between the read buffer and the first and second groups of interface terminals; and
wherein the selectively coupling includes selectively coupling the first group of interface terminals or the second group of interface terminals to the read buffer.

4. The method according to claim 2,
wherein the buffer comprises a write buffer;
wherein the multiplexer comprises a write multiplexer arranged between the write buffer and the first and second groups of interface terminals; and
wherein the selectively coupling includes selectively coupling the first group of interface terminals or the second group of interface terminals to the write buffer.

5. The method according to claim 2,
wherein the buffer comprises a read buffer and a write buffer;
wherein the multiplexer comprises:
a read multiplexer arranged between the read buffer and the first and second groups of interface terminals, and the selectively coupling includes selectively coupling the first group of interface terminals or the second group of interface terminals to the read buffer; and
a write multiplexer arranged between the write buffer and the first and second groups of interface terminals, and the selectively coupling includes selectively coupling the first group of interface terminals or the second group of interface terminals to the write buffer.

6. The method according to claim 1, comprising:
providing the first interface channel with a first group of transmitters and receivers; and
providing the second interface channel with a second group of transmitters and receivers.

7. The method according to claim 1, comprising:
controlling the multiplexer based on a channel select signal.

8. The method according to claim 1, comprising:
providing the memory interface in a memory controller.

9. The method according to claim 1, comprising:
providing the memory interface in an integrated circuit including a processor that communicates to the plurality of memory devices through the memory interface.

10. The method according to claim 1, comprising:
providing the memory interface in an integrated circuit having a memory buffer.

11. The method according to claim 11, wherein the memory buffer comprises an advanced memory buffer.

12. An integrated circuit comprising:
a memory interface circuit comprising:
a first interface channel configured to couple to at least one memory device;
a second interface channel configured to couple to at least one memory device; and
a multiplexer configured to select between the first interface channel and the second interface channel.

13. The integrated circuit according to claim 12, wherein the first interface channel and the second interface channel have a substantially identical configuration.

14. The integrated circuit according to claim 12, wherein the first interface channel comprises a first group of interface terminals and the second interface channel comprises a second group of interface terminals.

15. The integrated circuit according to claim 14,
wherein the memory interface circuit comprises a buffer; and
wherein the multiplexer is coupled between the buffer and the first and second groups of interface terminals to selectively couple the first group of interface terminals or the second group of interface terminals to the buffer.

16. The integrated circuit according to claim 15,
wherein the buffer comprises a read buffer; and
wherein the multiplexer comprises a read multiplexer arranged between the read buffer and the first and second groups of interface terminals to selectively couple the first group of interface terminals or the second group of interface terminals to the read buffer.

17. The integrated circuit according to claim 15,
wherein the buffer comprises a write buffer; and
wherein the multiplexer comprises a write multiplexer arranged between the write buffer and the first and second groups of interface terminals to selectively couple the first group of interface terminals or the second group of interface terminals to the write buffer.

18. The integrated circuit according to claim 15,
wherein the buffer comprises:
a read buffer; and
a write buffer; and
wherein the multiplexer comprises:
a read multiplexer arranged between the read buffer and the first and second groups of interface terminals to selectively couple the first group of interface terminals or the second group of interface terminals to the read buffer; and
a write multiplexer arranged between the write buffer and the first and second groups of interface terminals to selectively couple the first group of interface terminals or the second group of interface terminals to the write buffer.

19. The integrated circuit according to claim 14,
wherein the memory interface circuit comprises delay circuitry; and
wherein the multiplexer is coupled between the delay circuitry and the first and second groups of interface terminals to selectively couple the first group of interface terminals or the second group of interface terminals to the delay circuitry.

20. The integrated circuit according to claim 14,
wherein the memory interface circuit comprises control logic; and
wherein the multiplexer is coupled between the control logic and the first and second groups of interface terminals to selectively couple the first group of interface terminals or the second group of interface terminals to the control logic.

21. The integrated circuit according to claim 14, comprising:
a transmitter and/or a receiver for each of the interface terminals of the first group; and
a transmitter and/or a receiver for each of the interface terminals of the second group.

22. The integrated circuit according to claim 12,
wherein the first interface channel and the second interface channel are each configured to transfer data path signals and/or data strobe signals of a dynamic random access memory (DRAM) device.

23. An integrated circuit comprising:
a memory buffer device comprising:
a controller interface; and
a memory interface circuit having a first interface channel configured to couple to at least one memory device and a second interface channel configured to couple to at least one memory device, wherein the memory interface circuit comprises:
a multiplexer coupled between the controller interface and the first and second interface channels and configured to selectively couple the first interface channel and the second interface channel to the controller interface.

24. The integrated circuit according to claim 23, wherein the controller interface comprises a high-speed serial type interface.

25. An integrated circuit comprising:
a memory controller comprising:
a host interface; and;
a memory interface circuit comprising:
a first interface channel configured to couple to at least one memory device;
a second interface channel configured to couple to at least one memory device;
a multiplexer coupled between the host interface and the first interface channel and the second interface channel and configured to selectively couple the first interface channel or the second interface channel to the host interface.

26. The integrated circuit according to claim 25, wherein the first interface channel and the second interface channel are each configured to transfer data path signals and/or data strobe signals of a dynamic random access memory (DRAM) device.

27. An integrated circuit comprising
a processor comprising:
a processor core; and
a memory interface circuit comprising:
a first interface channel for coupling to at least one memory device;
a second interface channel for coupling to at least one memory device; and
means for selectively coupling the first interface channel or the second interface channel to the processor core.

28. A data processing system, comprising:
a processor;
a plurality of memory integrated circuits; and
a memory interface circuit configured to couple the memory integrated circuits to the processor, the memory interface circuit comprising:
a first interface channel;
a second interface channel; and
a multiplexer device configured to select between the first interface channel and the second interface channel.

29. The data processing system according to claim 28, wherein the processor includes the memory interface circuit.

30. The data processing system according to claim 28,
wherein the data processing system comprises a memory controller, and the memory controller includes the memory interface circuit.

31. The data processing system according to claim 28, comprising:
at least one memory module having a plurality of memory integrated circuits, wherein the at least one memory module comprises a memory buffer device coupled between the memory integrated circuits and the processor, and the memory buffer device includes the memory interface circuit.

32. A memory module, comprising:
a plurality of memory integrated circuits; and
a memory buffer device comprising:
a memory interface circuit comprising:
at least a first interface channel configured to couple to at least one of the memory integrated circuits and a second interface channel configured to couple to at least one of the memory integrated circuits; and
a multiplexer configured to select between the first interface channel and the second interface channel.

33. The memory module according to claim 32, wherein the memory module is a fully-buffered dual inline memory module (FB-DIMM) and the memory buffer device comprises an advanced memory buffer.
